(19) United States
(12) Patent Application Publication
(10) Pub. No.: US 2022/0415198 A1
(43) Pub. Date: Dec. 29, 2022

(54) METHOD AND APPARATUS FOR PROVIDING LEARNING CONTENT USING LEARNER KNOWLEDGE MAP

(71) Applicant: DAEKYO CO., Ltd., Seoul (KR)

(72) Inventor: Ho Jun KANG, Seoul (KR)

(21) Appl. No.: 17/851,555

(22) Filed: Jun. 28, 2022

(30) Foreign Application Priority Data
Jun. 29, 2021 (KR) 10-2021-0084648

(51) Int. Cl. G09B 7/04; G09B 7/07

(52) U.S. Cl. CPC G09B 7/04; G09B 7/07

(57) ABSTRACT

A method and apparatus for providing learning content. According to one embodiment of the present disclosure, the experienced difficulty analysis method and apparatus are provided for determining at least one current item parceling for providing learning to the learner using the learner knowledge map; generating a learning set based on all or part of items included in the current item parceling; and providing an item to a learner interface based on the learning set.

### CROSS-REFERENCE TO RELATED APPLICATIONS

This application is based on, and claims priority from, Korean Patent Application Number 10-2021-0084648, filed on Jun. 29, 2021, the disclosure of which is incorporated by reference herein in its entirety.

### BACKGROUND OF THE INVENTION

### 1. Field of the Invention

The present disclosure relates to a method and apparatus for providing learning content using a learner knowledge map. More particularly, the present disclosure relates to a method and apparatus for providing hyper-personalized learning content using a learner knowledge map.

### 2. Discussion of Related Art

The statements in this section merely provide background information related to the present disclosure and do not necessarily constitute prior art.

Recently, the development of customized learning platforms to provide personalized and customized learning contents and services has been actively progressed. However, the current customized learning platform diagnoses learning ability of a learner only superficially using indicators such as attendance, grades, learning progress, learning time, and the like, so it has a limitation that the diagnosis is not based on the learner's learning state. Accordingly, the current customized learning platform has a problem in that it cannot provide efficient and reliable contents or services to learners.

In addition, the learning content or service provided by the current customized learning platform is limited to selecting pre-stored content or service and providing it to a learner. To this end, a technology for generating a knowledge map by structuring learning contents or services based on knowledge is being developed. When a knowledge map is generated, it has the advantage of reducing the cost of knowledge search, identifying bottlenecks for facilitating the efficient flow of knowledge, and identifying the structural change process of knowledge according to time-series changes. However, the current customized learning platforms do not structure learning content or service with knowledge, but only generate a knowledge map using a conventional knowledge map generating tool. Accordingly, there is a problem in that it is not possible to generate or update the knowledge map by dynamically reflecting the learning state of the learner.

### BRIEF SUMMARY OF THE INVENTION

### Problem to be Solved

According to one aspect of the present disclosure, a main object is to determine customized content for providing learning to a learner based on a structurally generated learner knowledge map and provide the customized content to the learner.

According to one aspect of the present disclosure, a main object is to update the structurally generated learner knowledge map based on the learner's learning result data.

The objects of the present disclosure are not limited to the above-mentioned objects, and other objects not mentioned will be clearly understood by those skilled in the art from the following description.

### Technical Solution

According to one aspect of the present disclosure, a method of providing learning content using a learner knowledge map, that is a directional graph representing item parceling, which is a bundle of items having a meaning related to learning, as a node, the method comprising: determining whether or not the learner knowledge map has been generated, and generating the learner knowledge map based on learning information of a learner when it is determined that the learner knowledge map has not been generated, or obtaining the learner knowledge map from a datalake when it is determined that the learner knowledge map has been generated; determining at least one current item parceling for providing learning to the learner using the learner knowledge map; generating a learning set based on all or part of items included in the current item parceling; and providing an item to a learner interface based on the learning set.

According to another aspect of the present disclosure, the method of providing learning content further comprises updating the learner knowledge map based on the learner's learning result data for the learning set.

According to another aspect of the present disclosure, a learning content providing apparatus, comprising: one or more programmable processors; and a computer readable storage coupled to the one or more programmable processors and having instructions stored therein, wherein the instructions, when executed by the one or more programmable processors, cause the one or more programmable processors to perform each process of the learning content providing method according to any one of claims 1 to 15.

### Effects of the Invention

According to one aspect of the present disclosure, based on a learner knowledge map having item parceling, which is a bundle of items having a meaning related to the learning, as a node, the item parceling is determined as customized content for providing learning to the learner, a learning set is generated by selecting the item included in the determined item parceling, and the generated learning set is provided to the learner, so that appropriate learning content may be provided to the learner.

According to another aspect of the present disclosure, by updating the learner knowledge map based on the learning result of the learning set provided to the learner, the learner knowledge map may be dynamically changed according to the learning achievement of the learner.

Accordingly, when using the learning content providing method and apparatus according to various aspects of the present disclosure, a hyper-personalized customized learning service may be provided to the learner by using the learner knowledge map generated and updated to suit the learner.

Effects of the present disclosure are not limited to the above-mentioned effects, and other effects not mentioned will be clearly understood by those skilled in the art from the following description.

### BRIEF DESCRIPTION OF THE DRAWINGS

FIG. 1 is a conceptual diagram illustrating a customized learning platform according to one embodiment of the present disclosure.

FIG. 2 is a flowchart illustrating a method of providing learning content according to one embodiment of the present disclosure.

FIG. 3 is an exemplary diagram of a learner knowledge map according to one embodiment of the present disclosure.

FIG. 4 is an exemplary diagram extending a learner knowledge map according to one embodiment of the present disclosure.

### DETAILED DESCRIPTION OF THE INVENTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely for the purpose of differentiating one component from others but not to imply or suggest the substances, the order or sequence of the components. Throughout this specification, when parts “include” or “comprise” a component, they are meant to further include other components, not excluding thereof unless there is a particular description contrary thereto. The terms such as “unit,” “module,” and the like refer to units for processing at least one function or operation, which may be implemented by hardware, software, or a combination thereof.

The detailed description to be disclosed below in conjunction with the accompanying drawings is intended to illustrate exemplary embodiments of this disclosure and is not intended to illustrate the only embodiments that this disclosure may be implemented.

The present disclosure discloses a customized learning platform, which is a platform for providing customized learning to learners. More specifically, as a function of the customized learning platform, the present disclosure discloses a learning content providing method and apparatus for providing customized learning to learners using a learner knowledge map. The customized learning platform in the present disclosure may be Daekyo's USM platform, but is not limited thereto.

The method of providing learning content of the present disclosure is executed by a learning content provider and each component of the learning content provider performs each function through at least one processor, and includes a computer-readable storage that is connected to the processor and has instructions stored therein.

In the present disclosure, a learner interface is a physical medium or virtual medium implemented for temporary or permanent access to enable interaction between learners and objects or systems (e.g., apparatus, computer programs, etc.). The learner interface may mean, for example, a manner through which a website or an application program interacts with a learner.

The learner interface includes at least one input unit which can be manipulated by a user and at least one output unit which displays a result of the learner's use. The learner interface may include at least one object designed to interact with the learner, such as a display screen, a keyboard, a mouse, text, an icon, and a help. The learner interface is, for example, a web user interface (WUI), a graphical user interface (GUI), a command line interface (CLI), a touch user interface, a communication interface agent, a crossing-based interface, a gesture interface, an object-oriented user interface, a multi-screen interface, a voice user interface, an end user interface, or the like, but is not limited thereto.

In the present disclosure, datalake is a repository in which data used in the customized learning platform proposed by the present disclosure is stored, and may collect unstructured/semi-structured/structured data from various data sources. The datalake may be located on all or part of an on-premise environment, an edge computing environment, and a cloud environment. The datalake may include various interfaces for collecting, storing, accessing, searching, referencing, or cross-referencing data.

The present disclosure uses contents for providing a customized learning service, and items, item parceling, and models as unit of a bundle of the contents. The item is a minimum unit of customized content, and may be, for example, each question stored and managed by the datalake or received from an external database. These questions are contents developed and held by Daekyo, and may include Noonopi questions, Soluni questions, Summit questions, and Caihong questions, but are not limited to.

The item parceling is a bundle of items with meaning related to learning. The item parceling may be, for example, a concept corresponding to a ‘type’ of learning contents. One item parceling may belong to at least one model.

The model is a unit determined to be meaningful in learning and a bundle of item parceling. The model may be, for example, a concept corresponding to a ‘unit’ or ‘lesson’ of learning contents.

Examples of items included in metadata of the item, the item parceling, and the model in the present disclosure are shown in Table 1.

TABLE 1

| | Previous connection model, Importance, Difficulty, |
|---|---|
| Model | Daily learning requirement, Model, etc. |
| Item | Upper model, Pre-learned item parceling, Importance |
| parceling | between Item parceling, Difficulty between |
| | Item parceling, Minimum learning requirement |
| | (evaluation), Required accuracy, Pre-learned |
| | learning requirement (number of items), Number of |
| | mode pages, Number of model confirmation pages, |
| | Subject learning (number of items per page), |
| | Number of subject learning pages, Evaluation |
| | (number of items per page), Number of evaluation |
| | pages, Number of pages used, etc. |
| Item | Upper item parceling, Item type, Importance between |
| | Item parceling, Difficulty between Item parceling, |
| | Required solving time, Item display position, Item |
| | display type, Presence/Absence of involved item, etc. |

Such metadata may be subdivided into, for example, content configuration information metadata, learning information metadata, expression information metadata, and the like, to be stored and used.

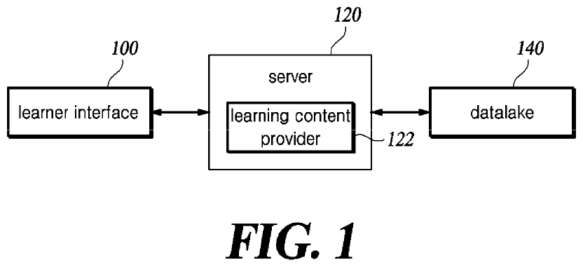

FIG. 1 is a conceptual diagram illustrating a customized learning platform according to one embodiment of the present disclosure.

The customized learning platform 10 according to one embodiment of the present disclosure is a platform for providing customized learning to learners, and includes all or part of a learner interface 100, a server 120 and a datalake 140. The customized learning platform 10 shown in FIG. 1 is one embodiment of the present disclosure, and not all components shown in FIG. 1 are essential components, and some components may be added, changed, or deleted in another embodiment. For example, in another embodiment, the customized learning platform may further include a coach interface (not shown) that transmits feedback according to a learning state of a learner.

Although FIG. 1 illustrates the customized learning platform 10 as an apparatus, this is for convenience of description, and in another embodiment, the customized learning platform may be implemented as a software module or processor that performs functions of each of the components 100 to 140.

The learner interface 100 interacts with the server 120 to provide customized content to the learner. Specifically, the learner interface 100 may access a web page or an application through which the server 120 provides a service according to a user's manipulation. The learner interface 100 may receive and transmit a learning set provided by the server 120 as customized content. The learner interface 100 may receive a learner's manipulation as an input and store it by itself, perform an operation on the input, or transmit it to the server 120. The learner interface 100 may receive and transmit feedback on the learner's manipulation from the server 120.

In order to provide the customized learning service, the server 120 provides a web page or application or other environment that the user can access. The server 120 interacts with the learner interface 100. For example, the server 120 may receive a request from the learner interface 100 to perform a function corresponding to the request, and transmit feedback thereon to the learner interface 100. The server 120 includes a learning content provider 122 that performs a customized learning method.

The learning content provider 122 generates a learner knowledge map, or loads the learner knowledge map generated by the learning content provider 122 from the datalake 140.

Here, the learner knowledge map is a data structure that represents item parceling, which is a bundle of items having a meaning related to learning, as a node, and may be a graph, a directed graph, or the like, but the learner knowledge map may be implemented without being limited to such a data structure. The learning content provider 122 may determine connection relationships between nodes on the learner knowledge map based on all or part of metadata of a model which is a bundle of item parceling, and metadata of the item parceling as a unit determined to be meaningful for learning.

For example, the learning content provider 122 may form an edge to indicate connection relationships between nodes based on all or part of the previous connection model of a model to which each item parceling belongs and the corresponding model, difficulty of the corresponding model, importance of the corresponding model, pre-learned item parceling, importance between item parceling, and difficulty between item parceling. Such an edge may be a directional edge, that is, an outgoing edge or an incoming edge. Due to the connection relationship between the item parceling, a cycle may be formed between the item parceling.

The learning content provider 122 may generate a learner knowledge map using a machine learning-based or artificial intelligence-based learner knowledge map creation model. In this case, the learner knowledge map creation model may generate a learner knowledge map for each of model, item parceling, and item by using metadata of the model, metadata of the item parceling, metadata of the item, learning information of the learner, and the like as features. Such a learner knowledge map creation model may generate a learning map capable of providing an optimal learning route to each learner by further learning the generated learner knowledge map for various learners and the process in which each learner knowledge map is updated. In this case, the update of the learner knowledge map described below may be performed by inputting data used as the basis for the update into the learner knowledge map creation model.

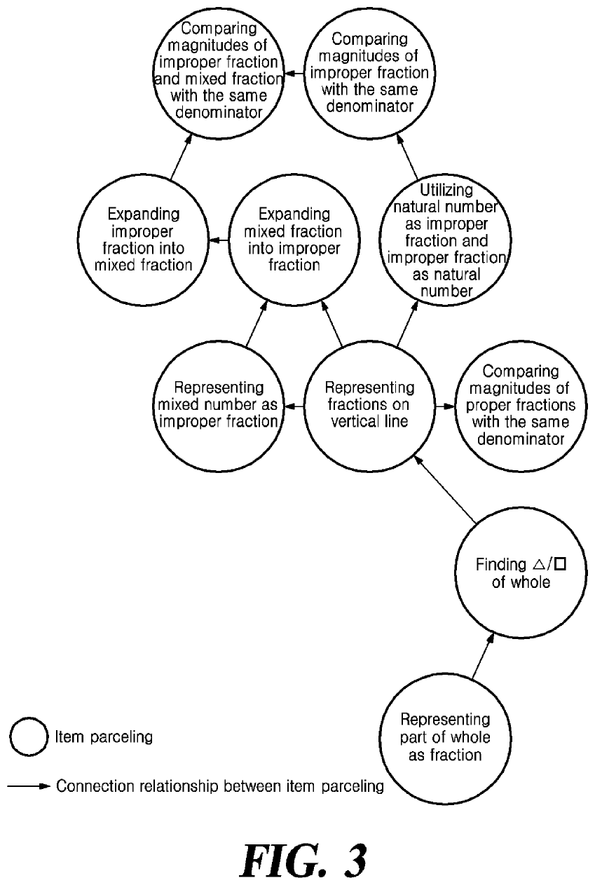

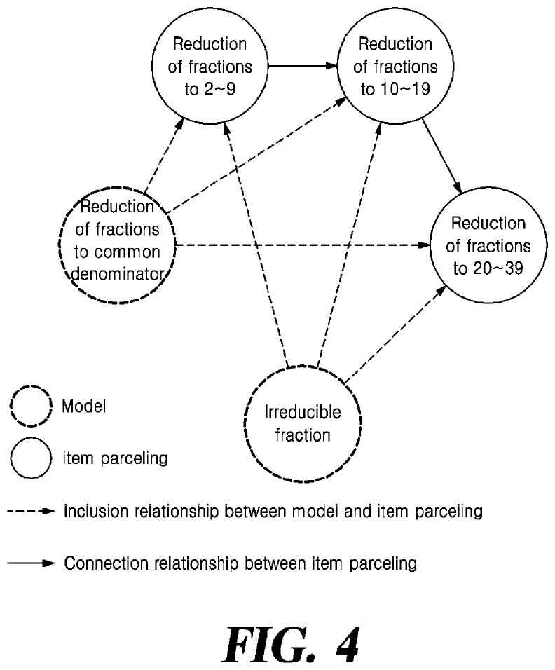

An example of the learner knowledge map generated by the learning content provider 122 will be described in detail with reference to FIGS. 3 and 4.

The learning content provider 122 determines a learning route of the learner based on the learner knowledge map. Specifically, the learning content provider 122 may generate a learning set to train a learner based on a connection relationship between item parceling. The learning content provider 122 may determine item parceling that meets a preset criterion among item parceling (hereinafter, “adjacent item parceling”) connected to the current item parceling through the outgoing edge as item parceling to be learned next and provide it to the learner interface 100.

Meanwhile, item parceling corresponding to each node of the learner knowledge map may display all or part of metadata of the model to which the corresponding item parceling belongs and metadata of the corresponding item parceling together. This allows a learner or a coach to obtain necessary information or insights on learning by referring to customized content provided by the customized learning platform 10 in various ways.

The learning content provider 122 may generate a learning set, which is a data structure in which an item to train the learner is structured, based on the generated or loaded learner knowledge map. To this end, the learning content provider 122 determines one or more current item parceling, which is item parceling for training the learner. The learning content provider 122 determines whether or not the item parceling that the learner has previously learned exists, and may determine the current item parceling among item parceling adjacent to the previously learned item parceling when it is determined that the previously learned item parceling exists. For example, the learning content provider 122 may calculate predictive accuracy, which is a predictive correct answer rate of a learner, for each adjacent item parceling, and determine the current item parceling based on the calculated predictive accuracy or recommend specific item parceling to the learner. The learning content provider 122 may further calculate a predictive quasi-estimation which predicts whether the learner will solve each item in time for adjacent item parceling, and may determine the current item parceling in further consideration of the calculated predictive quasi-estimation.

When the learning content provider 122 determines that there is no previously learned item parceling, the learning content provider 122 may determine the current item parceling from the learner knowledge map based on the learner's learning information and/or the metadata of the item parceling.

The learner's learning information is information related to the learner's learning, and may include learner's grade information, learner's level information, learner's offline learning result data, learner's pre-evaluation result data, and the like, but any information required to generate a learner knowledge map may be learning information in the present disclosure without being limited thereto. The pre-evaluation is performed by a learning set composed of at least one item in order to determine a level of a learner or to determine the item parceling for which the learner performs learning. The learning content provider 122 provides the learning set to the learner, and receives a result of the learner solving the learning set using the learner interface 100 to generate learning information. Accordingly, the learning information may further include, for example, learner's predictive accuracy, learner's actual accuracy, predictive quasi-estimation, actual quasi-estimation, learner's learning state information (e.g., peak, stability, helplessness, excitement, doziness), and the like.

Meanwhile, as shown in Table 2, the learning content provider 122 may provide all or some information of predictive accuracy, actual accuracy, predictive quasi-estimation, and actual quasi-estimation to the learner interface 100. Accordingly, the learner interface 100 may display all or part of the predictive accuracy, the actual accuracy, the predictive quasi-estimation, and the actual quasi-estimation for each item parceling. With respect to item parceling that the user has not actually learned, only predictive accuracy and/or predictive quasi-estimation may be displayed to be provided as a reference indicator for allowing the user to select learning of specific item parceling.

TABLE 2

| Item | | | | Actual | Predictive |
|---|---|---|---|---|---|
| parceling | | Actual | Predictive | quasi- | quasi- |
| identifier | Item parceling | accuracy | accuracy | estimation | estimation |
| 130303 | Find quotient | 0.958 | 0.133 | 0.874 | 0.989 |
| | until divisible | | | | |
| 130304 | (decimal) + | 0.823 | 0.111 | 0.823 | 0.989 |
| | (decimal) | | | | |
| 130305 | (natural | 0.833 | 0.133 | 0.833 | 0.978 |
| | number) + | | | | |
| | (decimal) | | | | |

Meanwhile, when an event occurs in which a learner transmits a request for learning specific item parceling to the server 100 using the learner interface 100, the learning content provider 122 may determine the requested item parceling as current item parceling. Such an event occurs, for example, when the learning content provider 122 may provide the learner with information on ‘backward’ recommendation or ‘skip’ recommendation of each item parceling.

The recommendation of backward or skip for each item parceling may be determined based on “complete learning criterion” which is a criterion for determining whether or not the learner knows the item parceling and the actual accuracy, predictive accuracy, actual quasi-estimation and/or predictive quasi-estimation. The complete learning criterion may be a reference value set for each item parceling or each model to which the item parceling belongs, and may be a value determined in consideration of a learning level and/or difficulty of a model to which the corresponding item parceling belongs.

When an expected achievement determined based on the predictive accuracy and/or the predictive quasi-estimation of each item parceling is equal to or greater than the complete learning criterion, the learning content provider 122 may recommend skip of the corresponding item parceling. When an actual achievement determined based on the actual accuracy and/or the actual quasi-estimation of each item is less than the complete learning criterion, the learning content provider 122 may recommend backward to the corresponding item parceling. Alternatively, when the expected achievement determined based on the predictive accuracy and/or the predictive quasi-estimation of each item is less than the complete learning criterion, the learning content provider 122 may recommend backward to the corresponding item parceling. Table 3 exemplarily shows cases where backward and skip of item parceling are recommended respectively.

TABLE 3

| Item | | Complete | | Predictive | | |
|---|---|---|---|---|---|---|
| parceling | Item | learning | Predictive | quasi- | Actual | |
| identifier | parceling | criterion | accuracy | estimation | achievement | Recommendation |
| 130303 | Find | 0.9 | 0.133 | 0.989 | — | |
| | quotient | | | | | |
| | until | | | | | |
| | divisible | | | | | |
| 130304 | (decimal) + | 0.9 | 0.111 | 0.989 | Actual | Backward |
| | (decimal) | | | | accuracy: | |
| | | | | | 0.823 | |
| | | | | | Quasi- | |
| | | | | | estimation: | |
| | | | | | 0.523 | |
| 130305 | (natural | 0.9 | 0.133 | 0.989 | Actual | Skip |
| | number) + | | | | accuracy: | |
| | (decimal) | | | | 0.823 | |
| | | | | | Actual quasi- | |
| | | | | | estimation: | |
| | | | | | 0.833 | |

When a learner selects skip and/or backward for specific item parceling through the learner interface 100, the learning content provider 122 may update the learner knowledge map to reflect the corresponding event. The learning content provider 122 may update the learner knowledge map by, for example, generating a new edge in the learner knowledge map or removing the existing edge.

The learning content provider 122 generates a learning set based on all or part of items included in the current item parceling. The learning content provider 122 may select an item to be provided to the learner from the items included in each of the current item parceling. Such selection may be performed by, for example, determining the number of items to be included in the learning set based on metadata of the current item parceling, and selecting as many items as the determined number. For example, as metadata of item parceling, the number of items may be determined based on the minimum learning requirement of each learning corner item (e.g., concept, concept confirmation, main learning, evaluation, utilization, etc.) to generate a learning set. As another example, the learning content provider 122 may select an item to be provided to a learner by using the number of model pages, the number of model confirmation pages, the number of main learning pages, the number of items per each main learning page, the number of evaluation pages, and the number of utilization pages.

The learning content provider 122 may generate a learning set by setting all or part of learning corner information on which an item is to be placed, page information on which an item is to be placed, and item number information on which the item is to be placed. This is to allow the learner interface 100 receiving the learning set to display each item at an appropriate location on each page (e.g., the location of the set item number on the set page of the set learning corner, etc.). Table 4 is a table exemplarily showing a learning set. In Table 4, when the item identifier is ‘random’, it means that an item is randomly selected from among the items belonging to the current item parceling.

TABLE 4

| Learning | Model | Item parceling | | | Item | Item |
|---|---|---|---|---|---|---|
| level | identifier | identifier | Learning corner | Page | number | identifier |
| 11 | m06 | 11-kc28 | Concept | 1 | 1 | a001 |
| 11 | m06 | 11-kc28 | Concept confirmation | 1 | 1 | Random |
| 11 | m06 | 11-kc28 | Main learning | 1 | 1 | a002 |
| 11 | m06 | 11-kc28 | Main learning | 1 | 2 | a003 |
| 11 | m06 | 11-kc28 | Evaluation | 1 | 1 | a050 |
| 11 | m06 | 11-kc28 | Evaluation | 1 | 2 | a051 |
| 11 | m06 | 11-kc28 | Evaluation | 2 | 1 | a061 |
| 11 | m06 | 11-kc28 | Evaluation | 2 | 2 | a063 |
| 11 | m06 | 11-kc28 | Utilization | 1 | 1 | Random |

Meanwhile, when the previously learned item parceling is included in the learning set again by the cycle between item parceling or by the recommendation of backward, the learning content provider 122 may select items of the learning set while excluding the previously selected item. Alternatively, the learning content provider 122 may select items of the learning set by including an item for which the learner has submitted a wrong answer or an item for which the learner has not solved in time.

The learning content provider 122 may provide each item to the learner interface 100 based on the generated learning set. For example, based on the learning set, the learning content provider 122 may display each of the selected items at the location of the item number set on the set page of the set learning corner. Such a display may be displayed according to information on the item display type included in the metadata of each selected item (e.g., no answer input, single answer (one correct answer), one answer (several correct answers), coloring, etc.), for example.

The learning content provider 122 may update the learner knowledge map based on the learner's learning result data for the current item parceling. The learning content provider 122 may perform change (creation/deletion/direction change, etc.) of the connection relationship between nodes of the learner knowledge map based on the actual accuracy and/or the actual quasi-estimation for the current item parceling included in the learning result data. Accordingly, the learning content provider 122 may reflect the learner's achievement in real time on the learner knowledge map to provide a customized learning service to the learner.

In order for the customized learning platform 10 to provide a customized learning service, the datalake 140 may store and manage all or part of the data which are pre-stored, or received from each apparatus 100 to 120, an external server (not shown) or an external database (not shown), or generated by itself. The data lake 140 may store and manage, for example, each item and metadata of each item, each item parceling and metadata of each item parceling, and each model and metadata of each model. The datalake 140 may store and manage, as information of each learner, all or part of information on each learner's pre-evaluation result, each learner's grade information, each learner's learning state information, each learner's last learning location (item parceling, model, level, etc.), learner knowledge map for each learner, predictive learning accuracy and quasi-estimation for each learner, actual learning accuracy and quasi-estimation of learning on which each learner has actually performed, statistics on each learner's group learning, and items, item parceling and model which have been previously learned by each learner, but these are exemplary only and information is not limited to the above.

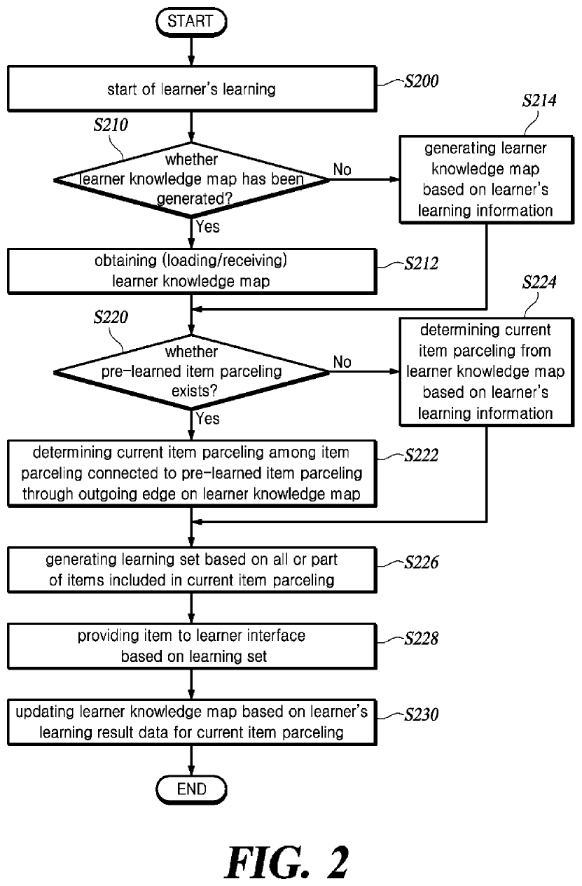

FIG. 2 is a flowchart illustrating a learning content providing method according to one embodiment of the present disclosure.

The learner starts learning using the learner interface 100 (S200). The start of learning may be performed, for example, when a learner accesses a web page or application through which the server 120 provides service using the learner interface 100, when a learner logs in to the web page or application through the learner interface 100, or when a learner manipulates the learner interface 100 to transmit a “start learning” request to the server 120 on the web page or application, but is not limited thereto.

The learning content provider 122 determines whether or not a learner knowledge map of the learner who requested learning has been generated (S210).

When it is determined that the learner knowledge map of the learner has been generated in step S210, the learning content provider 122 generates a learner knowledge map based on the learner's learning information (S214).

When it is determined that the learner knowledge map of the learner has been generated in step S210, the learning content provider 122 obtains the previously generated learner knowledge map. For example, the learning content provider 122 may load the pre-generated learner knowledge map from the datalake 140, receive the pre-generated learner knowledge map from an external database (not shown), or obtain the pre-generated learner knowledge map by referring the pre-generated learner knowledge map in the in-memory, but the present disclosure is not limited thereto.

The learner knowledge map obtained by the learning content provider 122 in step S212 may be a learner knowledge map generated by the same processes as those in step S214, but is not limited to being generated by such processes.

In order to provide customized learning to the learner, the learning content provider 122 determines whether there is an item parceling previously learned by the learner (S220). Such determination may be performed, for example, by obtaining information on the item parceling for which the learning was last performed in the case where there is a learning set which the learner has already learned or has stopped learning while learning.

When it is determined that the previously learned item parceling exists in step S220, the learning content provider 122 determines at least one current item parceling, which is an item parceling for providing learning to the learner, among item parceling adjacent to the previously learned item parceling on the learner knowledge map (S222). Such determination may be performed, for example, by computing and using predictive accuracy and/or predictive quasi-estimation of the adjacent item parceling.

Meanwhile, when the learner transmits to the server 100 a request for requesting learning of specific item parceling using the learner interface 100, steps S200 to S222 may be omitted. In this case, the learning content provider 122 may determine the item parceling for which learning is requested as the current item parceling and perform the following steps.

When it is determined that the previously learned item parceling does not exist in step S220, the learning content provider 122 determines at least one current item parceling that is item parceling for providing learning to the learner based on all or part of the learner's learning information and metadata of the item parceling (S224). For example, the learning content provider 122 may determine the first item parceling of the corresponding level as the current item parceling based on the learner's learning level. Alternatively, the learning content provider 122 may receive a request for inputting specific item parceling from the outside and determine the current item parceling.

The learning content provider 122 generates a learning set based on all or part of the items included in each of the current item parceling (S226). The learning content provider 122 may determine the number of items to be included in the learning set based on each metadata of the current item parceling, and may select as many items as the determined number to generate the learning set.

The learning content provider 122 provides an item to the learner interface 100 based on the generated learning set (S228). Since the learning set includes parameter values using which the learner interface 100 displays each item, the learner interface 100 may receive the learning set from the learning content provider 122 and display each item at an appropriate location on each page in an appropriate manner according to the data of the learning set.

The learning content provider 122 updates the learner knowledge map based on the learner's learning result data for the learning set (or the current item parceling included in the learning set) (S230). The learning content provider 122 may change the connection relationship between the nodes of the learner knowledge map based on the actual accuracy and/or the actual quasi-estimation for the current item parceling included in the learning result data.

However, step S230 may be performed after the learning content provider 122 receives the data for which the learner has learned the learning set from the learner interface 100 to generate learning result data, or receives the learning result data from the learner interface 100.

In FIG. 2, although the processes are described as sequentially executed, but this is merely illustrative of the technical idea of one embodiment of the present disclosure. In other words, since an ordinary skilled person in the art to which the embodiment of the present disclosure pertain may make various modifications and changes by changing the processes described in FIG. 2 or performing one or more of the processes in parallel without departing from the essential characteristics of the embodiment of the present disclosure, the present disclosure is not limited to the time-series order of FIG. 2.

FIG. 3 is an exemplary diagram showing the learner knowledge map according to one embodiment of the present disclosure.

As shown in FIG. 3, the learner knowledge map may represent each item parceling as a node, and the relationship between item parceling may be represented by an edge, particularly an outgoing edge. For example, the node of item parceling ‘Representing fractions on a vertical line’ is connected to each of the node ‘Utilizing natural number as improper fraction and improper fraction as natural number’, the node ‘Expanding mixed fraction into improper fraction’, and the node ‘Comparing magnitudes of proper fractions with the same denominator’, the node ‘Representing mixed number as improper fraction’ through the outgoing edge. That is, the node ‘Utilizing natural number as improper fraction and improper fraction as natural number’, the node ‘Expanding mixed fraction into improper fraction’, and the node ‘Comparing magnitudes of proper fractions with the same denominator’ and the node ‘Representing mixed number as improper fraction’ becomes adjacent nodes (or adjacent item parceling) of the node ‘Representing fractions on a vertical line’.

When the current item parceling is the node ‘Representing fractions on a vertical line, the learning content provider 122 determines the item parceling to be learned next according to a preset method among the adjacent nodes of the node ‘Representing fractions on a vertical line. In the learner knowledge map, the nodes and edges may be changed in real time through interaction with the learner interface 100, so that the item parceling to be learned next may be dynamically determined.

FIG. 4 is an exemplary diagram extending the learner knowledge map according to one embodiment of the present disclosure.

Referring to FIG. 4, the learner knowledge map may represent not only item parceling but also a model to which item parceling belongs as a node. In addition, the learner knowledge map may represent not only the relationship between item parceling but also the relationship between the item parceling and the model as an edge.

Referring to FIG. 4, it may be seen that one item parceling may belong to one or more models. For example, it may be seen that a node ‘Reduction of fractions to 2˜9’, which is a node representing item parceling, simultaneously belongs to a node ‘Reduction of fractions to a common denominator’ and a node ‘Irreducible fraction’, which are nodes representing a model.

Meanwhile, referring to FIG. 4, after learning the items of item parceling of ‘Reduction of fractions to 2˜9’, the learner sequentially learns the items of item parceling of ‘Reduction of fractions to 10˜19’ and then learns item parceling of ‘Reduction of fractions to 20˜39’. However, the learner knowledge map may vary depending on the actual achievement or predictive achievement of the previously learned item parceling, and an event may occur according to skip recommendation and/or backward recommendation, so the actual learning route may vary.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input apparatus, and at least one output apparatus, wherein the programmable processor may be a special-purpose processor or a general-purpose processor. Computer programs, which are also known as programs, software, software applications, or codes, contain instructions for a programmable processor and are stored in a “computer-readable recording medium.”

The computer-readable recording medium includes any types of recording apparatus on which data that can be read by a computer system are recordable. Examples of computer-readable recording medium include non-volatile or non-transitory media such as a ROM, CD-ROM, magnetic tape, floppy disk, memory card, hard disk, optical/magnetic disk, storage apparatuss, and the like. The computer-readable recording medium further includes transitory media such as data transmission medium. Further, the computer-readable recording medium can be distributed in computer systems connected via a network, wherein the computer-readable codes can be stored and executed in a distributed mode.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, a network apparatus, a set-top box, an embedded apparatus, a computer expansion module, a personal computer, a laptop, a personal data assistant (PDA), a cloud computing system, and a mobile apparatus.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

1. A method of providing learning content using a learner knowledge map, that is a directional graph representing item parceling, which is a bundle of items having a meaning related to learning, as a node, the method comprising:
determining whether or not the learner knowledge map has been generated, and generating the learner knowledge map based on learning information of a learner when it is determined that the learner knowledge map has not been generated, or obtaining the learner knowledge map from a datalake when it is determined that the learner knowledge map has been generated;
determining at least one current item parceling for providing learning to the learner using the learner knowledge map;
generating a learning set based on all or part of items included in the current item parceling; and
providing an item to a learner interface based on the learning set.

2. The method of claim 1, wherein the generating the learner knowledge map comprises generating the learner knowledge map based on result data of the learner performing a pre-evaluation as the learning information

3. The method of claim 1, wherein the generating the learner knowledge map comprises determining connection relationship between nodes based on metadata of a model which is a bundle of item parceling and metadata of the item parceling as a unit determined to be meaningful for learning.

4. The method of claim 1, wherein the determining the current item parceling comprises it is determined whether there exists item parceling which has previously been learned by the learner, and determining the current item parceling depending on the determination result.

5. The method of claim 4, wherein the determining the current item parceling comprises when it is determined that no previously learned item parceling exists, determining the current item parceling in further consideration of result data of the learner performing a pre-evaluation and metadata of each item parceling as the learning information.

6. The method of claim 4, wherein the determining the current item parceling comprises when it is determined that the previously learned item parceling exists, with respect to each of adjacent item parceling which is connected through an outgoing edge to the previously learned item parceling on the learner knowledge map, a predictive accuracy that is a predictive correct answer rate of the learner is calculated, and determining the current item parceling based on the calculated predictive accuracy.

7. The method of claim 6, wherein the determining the current item parceling comprises with respect to the adjacent item parceling, a predictive quasi-estimation that predicts whether the learner solves each item in time is further calculated, and determining the current item parceling by further considering the predictive quasi-estimation.

8. The method of claim 1, wherein the generating the learning set comprises generating the learning set by selecting an item to be provided to the learner from items included in each of the current item parceling according to metadata of the current item parceling.

9. The method of claim 8, wherein the metadata of the current item parceling includes all or part of the number of model pages, the number of model confirmation pages, the number of main learning pages, the number of questions per main learning page, the number of evaluation pages, and the number of utilized.

10. The method of claim 8, wherein the generating the learning set comprises the number of items to be included in the learning set is determined based on the metadata of the current item parceling, and selecting the determined number of items.

11. The method of claim 8, wherein the generating the learning set comprises generating the learning set by setting, with respect to each of the items for which the learning set is selected, all or a part of learning corner information on which the item is to be placed, page information on which the item is to be placed, and item number information on which the item is to be placed.

12. The method of claim 11, wherein the providing the item to the learner interface comprises displaying each of the selected items at a position of the item number set on the set page of the set learning corner, according to an item expression form information included in the metadata of each of the selected items.

13. The method of claim 1, further comprising:
updating the learner knowledge map based on the learner's learning result data for the learning set.

14. The method of claim 13, wherein the updating the learner knowledge map comprises
changing connection relationship between the nodes of the learner knowledge map based on accuracy and/or quasi-estimation for the current item parceling included in the learning result data.

15. The method of claim 13, wherein the updating the learner knowledge map comprises
updating the learner knowledge map by deleting at least one edge indicating connection relationship between the nodes to skip learning of specific item parceling.

16. A learning content providing apparatus, comprising:
one or more programmable processors; and
a computer readable storage coupled to the one or more programmable processors and having instructions stored therein,
wherein the instructions, when executed by the one or more programmable processors, cause the one or more programmable processors to perform each process of the learning content providing method according to claim 1.
